(19) United States
(12) Patent Application Publication
(10) Pub. No.: US 2021/0149574 A1
(43) Pub. Date: May 20, 2021

(54) DATA STORAGE DEVICE, OPERATING METHOD THEREOF AND STORAGE SYSTEM USING THE SAME

(71) Applicant: SK hynix Inc., Gyeonggi-do (KR)

(72) Inventor: Eu Joon BYUN, Gyeonggi-do (KR)

(21) Appl. No.: 16/870,636

(22) Filed: May 8, 2020

(30) Foreign Application Priority Data
Nov. 18, 2019 (KR) 10-2019-0147412

(51) Int. Cl. G06F 3/06

(52) U.S. Cl. CPC G06F 3/0634; G06F 3/0659; G06F 3/0653; G06F 3/0683; G06F 3/0625; G06F 3/0614; G06F 3/0644

(57) ABSTRACT

A data storage device includes a first data storage device configured to transmit a request for metadata to a second data storage device, receive the metadata from the second data storage device, and store the metadata when the data storage device satisfies a sleep condition and switches to a sleep mode and to transfer the metadata of the second data storage device, which is pre-stored in the first data storage device, to the corresponding second data storage device when the data storage device switches from the sleep mode to a wake-up mode and the second data storage device configured to transmit, when the request for the metadata is received from the first data storage device, the metadata to the first data storage device in response to the request for the metadata.

### CROSS-REFERENCE TO RELATED APPLICATION

The present application claims priority under 35 U.S.C. § 119(a) to Korean application number 10-2019-0147412, filed on Nov. 18, 2019, in the Korean Intellectual Property Office, which is incorporated herein by reference in its entirety.

### BACKGROUND

### 1. Technical Field

Various embodiments generally relate to a semiconductor device, and more particularly, to a data storage device, an operating method thereof, and a storage system using the same.

### 2. Related Art

In recent years, the paradigm for computer environments changed to ubiquitous computing in which computer systems may be used virtually anytime and anywhere. As a result, the use of portable electronic apparatuses such as mobile phones, digital cameras, and laptop computers have been increasing rapidly. Generally, portable electronic apparatuses use data storage devices that employ memory devices. Data storage devices may be used to store data used in the portable electronic apparatuses.

Data storage devices using memory devices have no mechanical driving units, exhibit good stability and endurance, fast information access rate, and low power consumption. Examples of data storage devices include a universal serial bus (USB) memory device, a memory card having various interfaces, a universal flash storage (UFS) device, a solid state drive (SSD), and the like.

Since there are many limitations related to batteries in mobile environments, research has been conducted to minimize power consumption.

Data storage devices need to retain data for operating firmware in memories even in a sleep state, and thus a relatively high amount of power is consumed even in the sleep state.

### SUMMARY

Embodiments are provided to a data storage device capable of reducing power consumption, an operating method thereof, and a storage system using the same.

In an embodiment of the present disclosure, a data storage device may include: a first data storage device configured to: transmit a request for metadata to a second data storage device, receive the metadata from the second data storage device, and store the metadata therein when the data storage device satisfies a sleep condition and switches to a sleep mode; and transfer the metadata of the second data storage device, which is stored in the first data storage device, to the data storage device when the second data storage device switches from the sleep mode to a wake-up mode; and wherein the second data storage device is configured to transmit metadata stored therein, when the request for the metadata is received from the first data storage device, to the first data storage device in response to the request for the metadata.

In an embodiment of the present disclosure, a storage system may include: a host device configured to set any one of a plurality of data storage devices as a first data storage device and set remaining data storage devices as a second data storage device, based on sleep environment conditions; and the plurality of data storage devices including the first data storage device and the second data storage device. The first data storage device may transmit a request for metadata to the second data storage device, receive the metadata from the second data storage device, and store the metadata when the plurality of data storage devices satisfy a sleep condition and switch to a sleep mode and transfer pre-stored metadata of the second data storage device to the corresponding second data storage device when the plurality of data storage devices switch from the sleep mode to a wake-up mode.

In an embodiment of the present disclosure, an operating method of a data storage device, the method may include: transmitting, by the first data storage device, a request for metadata to the second data storage device when a sleep condition for the first and second data storage device is satisfied; transmitting, by the second data storage device, the metadata to the first data storage device in response to the request; storing, by the first data storage device, the metadata of the second data storage device and a management table matched with the metadata in a memory of the first data storage device; and transmitting, by the first data storage device, the stored metadata to the second data storage device based on information of the stored management table when a wake-up condition of the first and second data storage device is satisfied and switches from a sleep mode to a wake-up mode.

In an embodiment of the present disclosure, an operating method of a system, the method may include: designating, by a host, a primary device and at least one secondary device among plural devices based on a condition of each of the secondary devices; providing, by each secondary device, the primary device with target data stored therein when entering a sleep mode; and returning, by the primary device, the target data to each secondary device when the corresponding secondary device exits the sleep mode, wherein the condition includes, for each of the secondary devices, one or a combination of available storage capacity, a size of the target data stored, and an estimated amount of current to keep the target data stored.

According to an embodiment of the present disclosure, a plurality of data storage devices are divided into a master and a slave and the metadata for operating firmware are stored and managed only in and by the master in a sleep mode and thus the power consumption for metadata management in the sleep state may be reduced.

These and other features, aspects, and embodiments are described in more detail below.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is a diagram illustrating a configuration of a storage system according to an embodiment of the present disclosure;

FIG. 2 is a diagram illustrating a metadata moving method according to an embodiment of the present disclosure;

FIG. 3 is a diagram illustrating a configuration of a data storage device according to another embodiment of the present disclosure;

FIGS. 4 to 6 are diagrams illustrating management tables according to an embodiment of the present disclosure;

FIGS. 7 and 8 are diagrams illustrating configurations of storage systems according to another embodiment of the present disclosure;

FIG. 9 is a diagram illustrating a configuration of a data storage device according to an embodiment of the present disclosure;

FIG. 10 is a flowchart explaining an operating method of a data storage device according to an embodiment of the present disclosure;

FIG. 11 is a diagram illustrating a data processing system including a solid state drive (SSD) according to an embodiment of the present disclosure;

FIG. 12 is a diagram illustrating a configuration of a controller, such as that in FIG. 11;

FIG. 13 is a diagram illustrating a data processing system including a data storage device according to an embodiment of the present disclosure;

FIG. 14 is a diagram illustrating a data processing system including a data storage device according to an embodiment of the present disclosure;

FIG. 15 is a diagram illustrating a network system including a data storage device according to an embodiment of the present disclosure; and

FIG. 16 is a diagram illustrating a nonvolatile memory included in a data storage device according to an embodiment of the present disclosure.

### DETAILED DESCRIPTION

Various embodiments of the present invention are described in greater detail below with reference to the accompanying drawings. However, features and aspects of the present invention may be configured or arranged differently than disclosed herein. Thus, the present invention is not limited to the disclosed embodiments. Rather, the present invention encompasses all modifications and variations of any of the disclosed embodiments that fall within the scope of the claims. Also, throughout the specification, reference to “an embodiment” or the like is not necessarily to only one embodiment, and different references to any such phrase are not necessarily to the same embodiment(s).

It will be understood that when an element or layer is referred to as being “on,” “connected to” or “coupled with” another element or layer, it can be directly on, connected or coupled with the other element or layer or one or more intervening elements or layers may be present. It will be further understood that the terms “comprises” and/or “comprising,” when used in this specification, do not preclude the existence or addition of other non-stated elements. Similarly, the indefinite articles “a” and “an” indicate one or more, unless stated or the context clearly indicates only one.

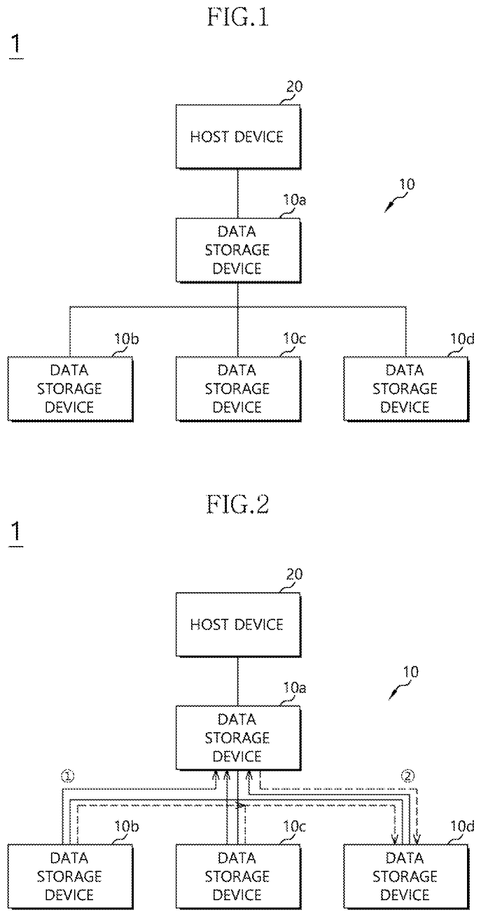

FIG. 1 is a diagram illustrating a configuration of a storage system according to an embodiment, and FIG. 2 is a diagram illustrating a metadata moving method according to an embodiment.

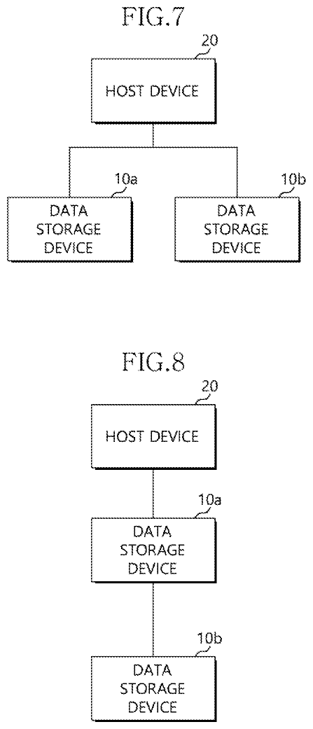

FIGS. 4 to 6 are diagrams illustrating management tables according to an embodiment, and FIGS. 7 and 8 are diagrams illustrating configurations of storage systems according to another embodiment. Hereinafter, a storage system including a data storage device is described with reference to FIGS. 1 and 2 together with FIGS. 4 to 8.

Referring to FIG. 1, a storage system 1 may include a host device 20 and a data storage device 10.

The host device 20 may set any one of a plurality of data storage devices 10a, 10b, 10c, and 10d as a first data storage device, e.g., data storage device 10a, and set each of the remaining data storage devices 10b, 10c, and 10d as a second data storage device, based on sleep environment condition(s). The first data storage device 10a may refer to a data storage device configured to store metadata of the second data storage devices 10b, 10c, and 10d in a memory of the first data storage device 10a in a sleep mode. The first data storage device 10a may be a master and the second data storage devices 10b, 10c, and 10d may be slaves.

The metadata may be for operating firmware.

The host device 20 may request and receive the sleep environment condition(s) to and from the plurality of data storage devices 10a to 10d. The sleep environment conditions may include an estimated current consumption amount required to maintain the metadata in a memory of the first data storage device 10a in the sleep mode, an available space of the memory of each of the data storage is devices 10a to 10d, and/or a size of the metadata to be maintained in the sleep state.

The available space of the memory means a space for storing additional data in the memory. Information may be requested by the host 20 to determine whether an available space sufficient to store the metadata of the second data storage devices is present in the memory.

Specifically, the host device 20 may request and receive the sleep environment condition(s) from the plurality of data storage devices 10a to 10d, which are directly or indirectly coupled to the host device 20, to set the master and the slaves among the plurality of data storage devices 10a to 10d, based on a method to be described. The sleep environment conditions means environment information to maintain the metadata while each of the data storage devices 10a to 10d is in the sleep mode. Such information may include the estimated current consumption amount, the available space of the memory, and the size of the metadata to be maintained in the sleep state as described above. However, the sleep environment condition(s) is not limited to those specific items of information; other suitable information may be included depending on operating and use considerations.

First, the host device 20 may set a data storage device having the largest available space of the memory among the plurality of data storage devices 10a to 10d as the master. The host device 20 may first consider the available space of the memory among the plurality of sleep environment condition(s) when setting the master among the data storage devices. However, this is not limited thereto and the sleep environment condition(s), which is to be first considered to set the master among the plurality of data storage devices 10a to 10d, may be changed according to needs. For example, the host device 20 may also first consider another condition among the sleep environment condition(s) other than the available space of the memory when setting the master among the data storage devices.

When all the sleep environment conditions received from the plurality of data storage devices 10a to 10d are the same as each other, the host device 20 may set a data storage device, which has the smallest estimated current consumption amount required to maintain the metadata in the memory among the sleep environment conditions, as the master among the plurality of data storage devices 10a to 10d.

For example, that all the same sleep environment conditions of the plurality of data storage devices are the same as each other may mean that the sleep environment conditions of the plurality of data storage devices, for example, the estimated current consumption amounts required to maintain the metadata in the memories in the sleep mode, the available spaces of the memories, and the sizes of the metadata to be maintained in the sleep state are similar to each other within permissive reference errors.

In another example, that all the same sleep environment conditions of the plurality of data storage devices are the same as each other may mean that other than the estimated current consumption amounts required to maintain the metadata in the memories in the sleep mode, the available spaces of the memories and the sizes of the metadata to be maintained in the sleep state are the same as each other or are similar to each other within the permissive reference errors.

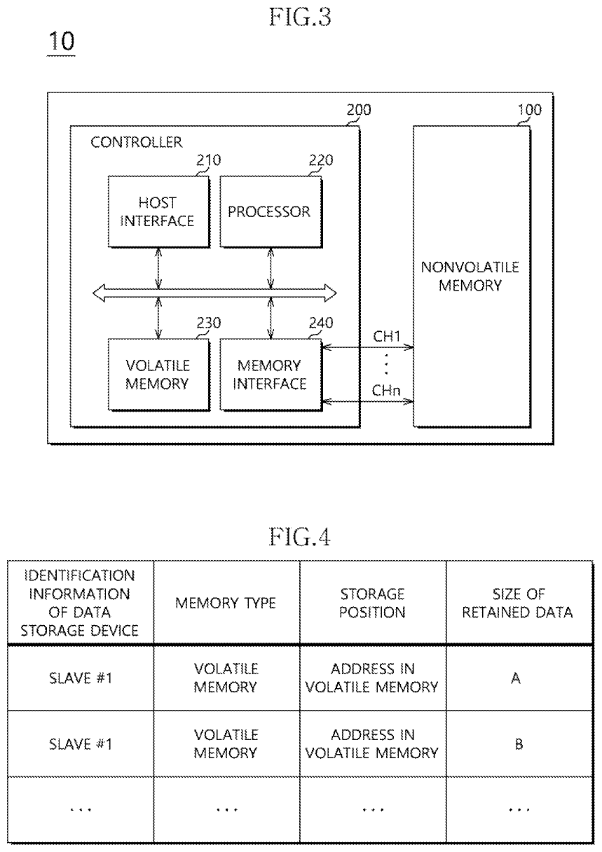

Referring to FIG. 3, the data storage device 10 according to an embodiment may store data to be accessed by the host device 20 such as a mobile phone, an MP3 player, a laptop computer, a desktop computer, a game player, a television (TV), an in-vehicle infotainment system, and the like. The data storage device 10 may refer to a memory system.

The data storage device 10 may be configured as any of various types of storage devices according to an interface protocol coupled to the host device. For example, the data storage device 10 may be configured as a solid state drive (SSD), a multimedia card in the form of MMC, eMMC, RS-MMC, and micro-MMC, a secure digital card in the form of SD, mini-SD, and micro-SD, a universal serial bus (USB) storage device, a universal flash storage (UFS) device, a personal computer memory card international association (PCMCIA) card type storage device, a peripheral component interconnection (PCI) card type storage device, a PCI Express (PCI-E) card type storage device, a compact flash (CF) card, a smart media card, and/or a memory stick.

The data storage device 10 may be manufactured as any of various types of packages. For example, the data storage device 10 may be manufactured as a package on package (POP), a system in package (SIP), a system on chip (SOC), a multi-chip package (MCP), a chip on board (COB), a wafer-level fabricated package (WFP), and/or a wafer-level stack package (WSP).

The data storage device 10 may include a nonvolatile memory 100 and a controller 200.

The nonvolatile memory 100 may be operated as a storage medium of the data storage device 10. The nonvolatile memory 100 may include any of various types of nonvolatile memories according to the type of memory cells therein, such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase-change random access memory (PRAM) using a chalcogenide alloy, and a resistive random access memory (ReRAM) using a transition metal compound.

The nonvolatile memory 100, which is described in detail with reference to FIG. 16, may include a memory cell array 110 including a plurality of memory cells MC arranged in regions in which a plurality of word lines WL1 to WLm and a plurality of bit lines BL1 to BLn intersect. For example, each of the memory cells in the memory cell array 110 may be a single-level cell (SLC) in which a single bit data (for example, 1-bit data) is to be stored, a multi-level cell (MLC) in which 2-bit data is to be stored, a triple-level cell (TLC) in which 3-bit data is to be stored, and a quad-level cell (QLC) in which 4-bit data is to be stored. The memory cell array 110 may include at least one of SLCs, MLCs, TLCs, and QLCs. The memory cell array 110 may include memory cells arranged in a two-dimensional (2D) horizontal structure or memory cells arranged in a 3D vertical structure.

The controller 200 may control overall operation of the data storage device 10 through driving of firmware or software loaded into a volatile memory 230. The controller 200 may decode and drive a code-type instruction or algorithm such as firmware or software. The controller 200 may be implemented with hardware or a combination of hardware and software.

The controller 200 may include a host interface 210, a processor 220, the volatile memory 230, and a memory interface 240. Although not shown in FIG. 3, the controller 200 may further include an error correction code (ECC) engine which generates a parity by ECC encoding write data provided from the host device 20 and ECC decodes read data read out from the nonvolatile memory 100 using the parity. The ECC engine may be provided within or externally to the memory interface 240.

The host interface 210 may perform interfacing between the host device 20 and the data storage device 10 according to a protocol of the host device. For example, the host interface 210 may communicate with the host device through any of a USB protocol, a UFS protocol, an MMC protocol, a parallel advanced technology attachment (PATA) protocol, a serial advanced technology attachment (SATA) protocol, a small computer system interface (SCSI) protocol, a serial attached SCSI (SAS) protocol, a PCI protocol, and/or a PCI-E protocol.

The processor 220 may be configured as a micro control unit (MCU) and/or a central processing unit (CPU). The processor 220 may process requests transmitted from the host device 20. To process requests transmitted from the host device, the processor 220 may drive a code-type instruction or algorithm (for example, firmware) loaded into the volatile memory 230 and control operations of internal function blocks such as the host interface 210, the volatile memory 230, and the memory interface 240 and the nonvolatile memory 100.

The processor 220 may generate control signals for controlling operations of the nonvolatile memory 100 based on the requests transmitted from the host device and provide the generated control signals to the nonvolatile memory 100 through the memory interface 240.

The volatile memory 230 may be configured as a dynamic random access memory (DRAM) or a static random access memory (SRAM). The volatile memory 230 may store the firmware driven through the processor 220. The volatile memory 230 may also store data (for example, metadata) for driving the firmware. For example, the volatile memory 230 may be operated as a working memory of the processor 220. Although not shown in FIG. 3, the controller 200 may further include a processor dedicated memory arranged for ready access by the processor 220; the firmware and metadata stored in the volatile memory 230 may be loaded into the processor dedicated memory.

The volatile memory 230 may be configured to include a data buffer configured to temporarily store write data to be transmitted to the nonvolatile memory 100 from the host device or read data to be transmitted to the host device from the nonvolatile memory 100. For example, the volatile memory 230 may be operated as a buffer memory of the processor 220.

It has been illustrated in FIG. 3 that the volatile memory 230 is provided within the controller 200, but the volatile memory 230 may be provided externally to the controller 200.

The memory interface 240 may control the nonvolatile memory 100 according to control of the processor 220. When the nonvolatile memory 100 is configured as a NAND flash memory, the memory interface 240 may refer to a flash control top (FCT). The memory interface 240 may transmit control signals generated through the processor 220 to the nonvolatile memory 100. The control signals may include a command, an address, an operation control signal, and the like for controlling the operations of the nonvolatile memory 100. The operation control signal may include, for example, a chip enable signal, a command latch enable signal, an address latch enable signal, a write enable signal, a read enable signal, a data strobe signal, and the like, but the present invention is not limited to these specific signals. The memory interface 240 may transmit write data to the nonvolatile memory 100 or receive read data from the nonvolatile memory 100.

The memory interface 240 and the nonvolatile memory 100 may be coupled through a plurality of channels CH1 to CHn, respectively. The memory interface 240 may transmit signals such as a command, an address, an operation control signal, and data (for example, write data) to the nonvolatile memory 100 through the plurality of channels CH1 to CHn. The memory interface 240 may receive a status signal (for example, ready/busy), data (for example, read data) and the like from the nonvolatile memory 100 through the plurality of channels CH1 to CHn.

Referring to FIG. 2, when the plurality of data storage devices 10a to 10d satisfy a sleep condition and thus switch to the sleep mode, the first data storage device 10a may send a request to the second data storage devices 10b to 10d for respective metadata stored therein, receive the metadata from the second data storage devices 10b to 10d, and store the metadata in the first data storage device 10a.

Referring to FIG. 2, when the data storage device 10a is the master, the first data storage device 10a may monitor whether the plurality of data storage devices 10a to 10d satisfy the sleep condition and request the metadata to the second data storage devices 10b to 10d as the slaves when it is determined that the sleep condition is satisfied. The sleep condition may refer to a state in which the host device 20 is idle for a specific time or more or a state in which a command is not received from the host device 20 for a specific time or more. Whether the sleep condition is satisfied may be determined through the plurality of data storage devices 10a to 10d or the host device 20.

When the request for the metadata transmitted from the first data storage device 10a is received, the second data storage devices 10b to 10d may transmit the metadata to the first data storage device 10a in response to the request for metadata (\textcircled{1}).

In another embodiment, when the data storage device 10d is the first data storage device, the second data storage devices 10a, 10c, and 10d may transmit the metadata to the first data storage device 10d (\textcircled{2}).

Accordingly, in the present disclosure, the first data storage device is not selected based on proximity to the host device 20; rather, the first data storage device is selected based on the sleep environment condition(s). The master and the slave may be selected through the host device 20 or through data exchange between the plurality of data storage devices 10a to 10d.

When the plurality of data storage devices 10a to 10d switch from the sleep mode to the wake-up mode, the first data storage device 10a may transfer the stored metadata of the second data storage devices 10b to 10d to the second data storage devices 10b to 10d, respectively.

Referring to FIG. 3, when the sleep condition is satisfied, the processor 220 of the data storage device 10 (for example, 10a of FIGS. 1 and 2) may request and receive the metadata from the second data storage devices 10b to 10d and store the metadata and the management table matched with the metadata in a memory within the first data storage device 10a. The memory may be the volatile memory 230 or the nonvolatile memory 240 of the first data storage device 10a.

Referring to FIGS. 4 to 6, the management table may include identification information of the second data storage devices 10b to 10d, a type of the memory in which the metadata is stored within the first data storage device 10a, a position in which the metadata is stored within the memory, and a size of the stored metadata of the second data storage devices 10b to 10d.

When the plurality of data storage devices 10a to 10d satisfy wake-up condition(s) and thus switch from the sleep mode to the wake-up mode, the processor 220 of the first data storage device 10a may transmit the stored metadata to the second data storage devices 10b to 10d, respectively, based on the information of the management table stored in the first data storage device 10a.

For example, referring to FIG. 4, the processor 220 may determine a position, in which the metadata of the data storage device 10b (slave #1) is stored, in a memory of the first data storage device 10a based on the management table, acquire the metadata from the corresponding position, and transmit the metadata to the data storage device 10b.

The memory may store the metadata and the management table and provide the stored metadata and the stored management table according to the request of the processor 220. The memory may be the volatile memory 230 or the nonvolatile memory 100. Due to the characteristic of the memory, the data read and write rates for the metadata when the metadata and the management table are stored in the volatile memory 230 may be higher than those when the metadata and the management table are stored in the nonvolatile memory 100.

For example, the processor 220 may store all the metadata of the second data storage devices in the volatile memory 230 or in the nonvolatile memory 100. In another example, the processor 220 may divide the metadata of the second data storage devices and store the divided metadata in the volatile memory 230 and the nonvolatile memory 100, respectively.

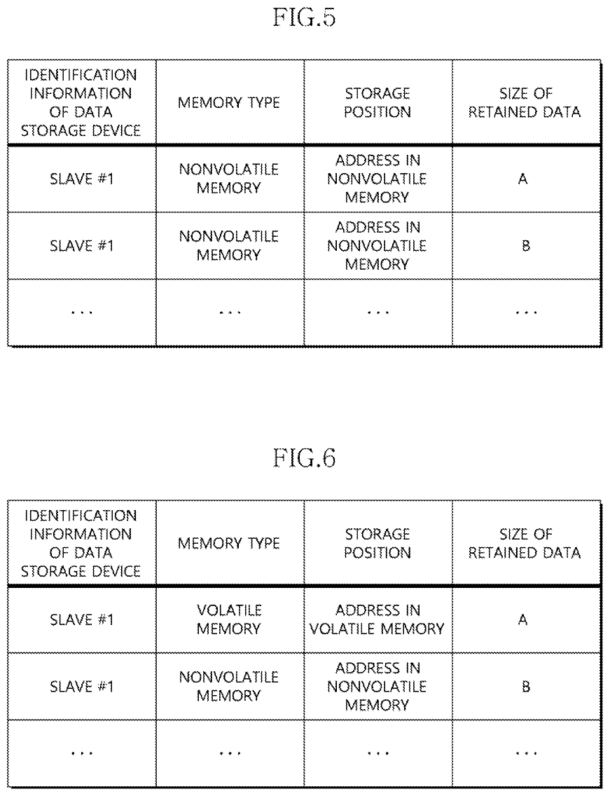

FIG. 4 illustrates the management table for the situation in which all the metadata are stored in the volatile memory 230, FIG. 5 illustrates the management table for the situation in which all the metadata are stored in the nonvolatile memory 100, and FIG. 6 illustrates the management table for the situation in which some of the metadata are stored in the nonvolatile memory 100 and some are stored in the volatile memory 230.

The processor 220 may store the metadata in the SLCs of nonvolatile memory 100 when the metadata is stored in the nonvolatile memory 100.

Referring to FIGS. 1, 2, 7, and 8, one or more second data storage devices 10b to 10d may be provided.

As illustrated in FIG. 7, the first data storage device 10a and the second data storage device 10b are coupled in parallel to the host device 20. That is, each data storage device is coupled directly to the host device 20.

As illustrated in FIGS. 1, 2, and 8, the first data storage device 10a and the second data storage devices 10b to 10d have a subordinate connection relationship that the first data storage device 10a or any one of the second data storage devices 10b to 10d is directly coupled to the host device 20 and other than the data storage device 10a directly coupled to the host device 20, the remaining data storage devices 10b to 10d are coupled to the data storage device 10a directly coupled to the host device 20.

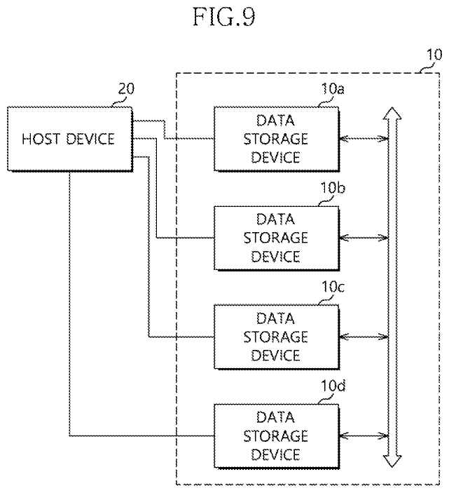

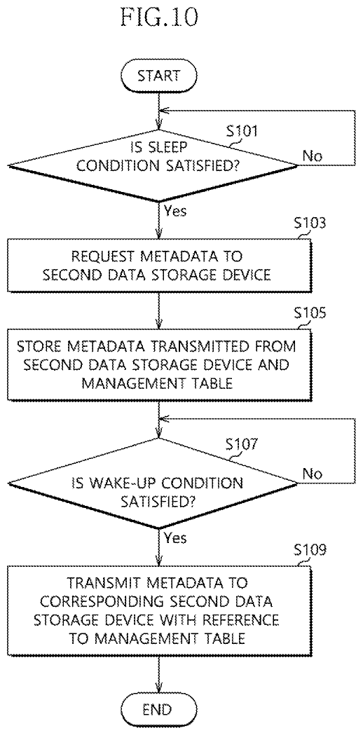

FIG. 9 is a diagram illustrating a configuration of a data storage device according to an embodiment.

Referring to FIG. 9, the data storage device 10 may include the first data storage device 10a and the second data storage devices 10b to 10d.

When the data storage devices satisfy the sleep condition and switch to the sleep mode, the first data storage device 10a may send a request to the second data storage devices 10b to 10d for metadata stored therein, receive the metadata from the second data storage devices, and store the metadata. The metadata may be metadata for operating firmware.

When the data storage devices switch from the sleep mode to the wake-up mode, the first data storage device 10a may transfer the stored metadata of the second data storage devices 10b to 10d to the second data storage devices 10b to 10d. In doing so, metadata is transferred back to the second data storage device from which it came.

As illustrated in FIG. 3, the first data storage device 10a may include the processor 220, the volatile memory 230, and the nonvolatile memory 100.

When the sleep condition of the plurality of data storage is devices 10a to 10d is satisfied, the processor 220 may request and receive the metadata from the second data storage devices 10b to 10d and store the metadata and the management table matched with the metadata in a memory within the first data storage device 10a. The management table may include identification information for each of second data storage devices 10b to 10d, including the type of the memory (e.g., volatile or nonvolatile) in which the metadata is stored within the first data storage device 10a, a position at which the metadata is stored within the memory, and the size of the stored metadata.

When the plurality of data storage devices 10a to 10d satisfy the wake-up condition and switch from the sleep mode to the wake-up mode, the processor 220 may transmit the stored metadata of the second data storage devices 10b to 10d to the second data storage devices 10b to 10d based on the information of the management table stored in the first data storage device 10a.

The memory may store the metadata of the second data storage devices 10b to 10d and the management table and provide the stored metadata and management table according to the request of the processor 220. The memory may be the volatile memory 230 or the nonvolatile memory 100.

For example, the processor 220 may store all the metadata in the volatile memory 230 or in the nonvolatile memory 100. In another example, the processor 220 may divide the metadata and store one portion of the metadata in the volatile memory 230 and another portion in the nonvolatile memory 100.

The processor 220 may store the metadata in the SLCs of nonvolatile memory 100 when the metadata is stored in the nonvolatile memory 100.

When the request for the metadata transmitted from the first data storage device 10a is received, the second data storage devices 10b to 10d may transmit the metadata thereof to the first data storage device 10a in response to the request for the metadata.

One or more second data storage devices 10b to 10d may be provided.

As illustrated in FIG. 7, the first data storage device 10a and the second data storage device 10b are coupled in parallel to the host device 20.

As illustrated in FIGS. 1, 2, and 8, the first data storage device 10a and the second data storage devices have a subordinate connection relationship that the first data storage device 10a or any one of the second data storage devices 10b to 10d is directly coupled to the host device 20 and other than the data storage device 10a directly coupled to the host device 20, the remaining data storage devices 10b to 10d are coupled to the data storage device 10a directly coupled to the host device 20.

FIG. 10 is a flowchart explaining an operating method of a data storage device according to an embodiment.

Referring to FIG. 10, when the sleep condition is satisfied (Yes, at S101), the first data storage device 10a may request the second data storage devices 10b to 10d to send their metadata to the first data storage device 10a (S103).

As the second data storage devices 10b to 10d transmit the metadata to the first data storage device 10a, the first data storage device 10a may store the metadata transmitted from the second data storage devices 10b to 10d and the management table matched with the metadata in a memory within the first data storage device 10a (S105). The memory may be the volatile memory 230 or the nonvolatile memory 100.

The management table may include identification information for each of the second data storage devices 10b to 10d, including the type of memory in which the metadata is stored within the second data storage devices 10b to 10d, the position at which the metadata is stored within the memory, and the size of the stored metadata.

In operation S105, the first data storage device 10a may store all the metadata of the second data storage devices 10b to 10d in the volatile memory 230 or in the nonvolatile memory 100, or the first data storage device 10a may divide the metadata and store divided portion of the metadata in the volatile memory 230 and store another portion in the nonvolatile memory 100. In the latter embodiment, all metadata from a particular second data storage device is stored in the memory.

When the data storage devices 10a to 10d satisfy the wake-up conditions and switch from the sleep mode to the wake-up mode (Yes at S107), the first data storage device 10a may transmit the metadata presently stored in the first data storage device 10a back to the second data storage devices 10b to 10d. To do so, information of the management table is used to determine which metadata is to be transmitted to which second data storage device (S109). Thus, a particular piece of metadata initially retrieved by the first data storage device 10a from a particular one of the second data storage device when the latter device enters sleep mode is later returned to that same second storage device when it wakes up.

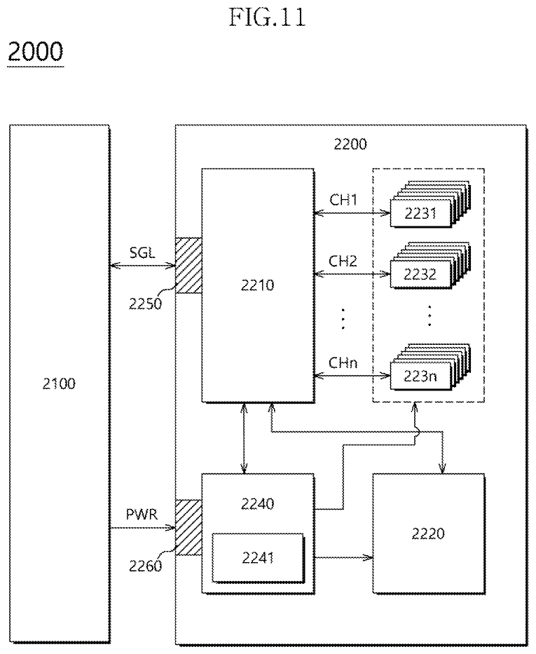

FIG. 11 is a block diagram illustrating a data processing system including a solid state drive (SSD) according to an embodiment. Referring to FIG. 11, a data processing system 2000 may include a host device 2100 and a solid state drive (SSD) 2200.

The SSD 2200 may include a controller 2210, a buffer memory device 2220, nonvolatile memories 2231 to 223n, a power supply 2240, a signal connector 2250, and a power connector 2260.

The controller 2210 may control overall operation of the SSD 2200.

The buffer memory device 2220 may temporarily store data which are to be stored in the nonvolatile memories 2231 to 223n. Further, the buffer memory device 2220 may temporarily store data which are read out from the nonvolatile memories 2231 to 223n. The data temporarily stored in the buffer memory device 2220 may be transmitted to the host device 2100 or the nonvolatile memories 2231 to 223n according to control of the controller 2210.

The nonvolatile memories 2231 to 223n may be used as storage media of the SSD 2200. The nonvolatile memories 2231 to 223n may be coupled with the controller 2210 through a plurality of channels CH1 to CHn, respectively. One or more nonvolatile memories may be coupled to one channel. The nonvolatile memories coupled to the same channel may be coupled to the same signal bus and data bus.

The power supply 2240 may provide power PWR inputted through the power connector 2260 to the inside of the SSD 2200. The power supply 2240 may include an auxiliary power supply 2241. The auxiliary power supply 2241 may supply power to allow the SSD 2200 to be properly terminated when sudden power-off (SPO) occurs. The auxiliary power supply 2241 may include large capacity capacitors capable of charging the power PWR.

The controller 2210 may exchange a signal SGL with the host device 2100 through the signal connector 2250. The signal SGL may include a command, an address, data, and the like. The signal connector 2250 may be configured as any of various types of connectors according to an interface scheme between the host device 2100 and the SSD 2200.

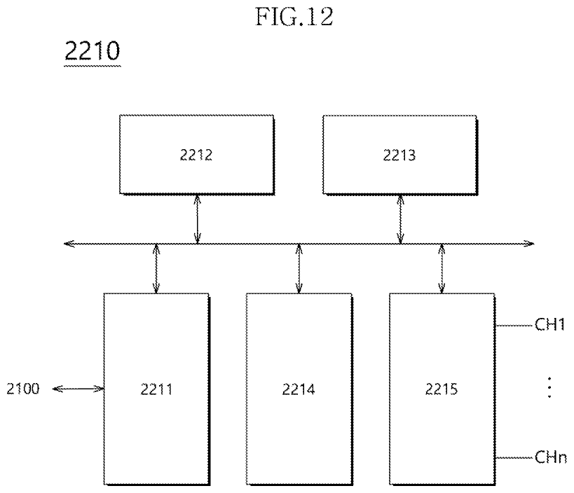

FIG. 12 is a block diagram illustrating the controller illustrated in FIG. 11. Referring to FIG. 12, the controller 2210 may include a host interface 2211, a control component 2212, a random access memory 2213, an error correction code (ECC) component 2214, and a memory interface 2215.

The host interface 2211 may provide interfacing between the host device 2100 and the SSD 2200 according to a protocol of the host device 2100. For example, the host interface 2211 may communicate with the host device 2100 through any of SD, USB, MMC, embedded MMC (eMMC), PCMCIA, PATA, SATA, SCSI, SAS, PCI, PCI-E, and UFS protocols. In addition, the host interface 2211 may perform a disk emulating function of supporting the host device 2100 to recognize the SSD 2200 as a general-purpose data storage device, for example, a hard disk drive (HDD).

The control component 2212 may analyze and process the signal SGL inputted from the host device 2100. The control component 2212 may control operations of internal function blocks according to firmware or software for driving the SSD 2200. The random access memory 2213 may be used as a working memory for driving such firmware or software.

The ECC component 2214 may generate parity data of data to be transmitted to the nonvolatile memories 2231 to 223n. The generated parity data may be stored, along with the data, in the nonvolatile memories 2231 to 223n. The ECC component 2214 may detect errors of data read out from the nonvolatile memories 2231 to 223n based on the parity data. When the detected errors are within a correctable range, the ECC component 2214 may correct the detected errors.

The memory interface 2215 may provide control signals such as commands and addresses to the nonvolatile memories 2231 to 223n according to control of the control component 2212. The memory interface 2215 may exchange data with the nonvolatile memories 2231 to 223n according to control of the control component 2212. For example, the memory interface 2215 may provide data stored in the buffer memory device 2220 to the nonvolatile memories 2231 to 223n or provide data read out from the nonvolatile memories 2231 to 223n to the buffer memory device 2220.

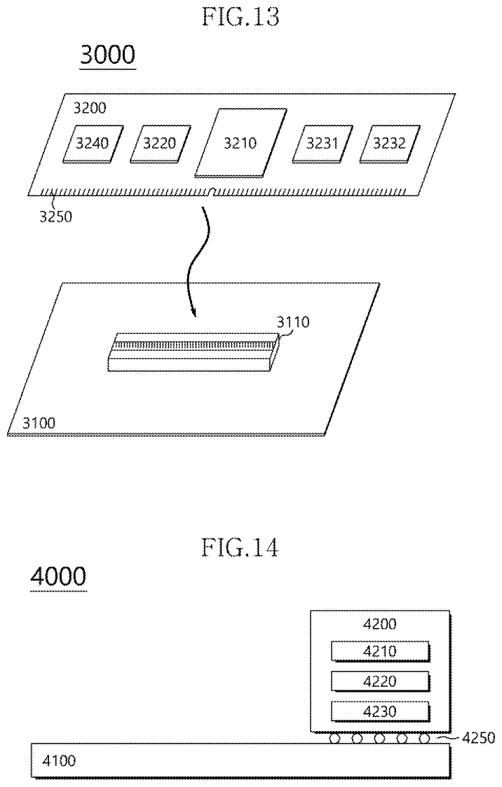

FIG. 13 is a diagram illustrating a data processing system including a data storage device according to an embodiment. Referring to FIG. 13, a data processing system 3000 may include a host device 3100 and a data storage device 3200.

The host device 3100 may be configured in the form of a board such as a printed circuit board. Although not shown in FIG. 13, the host device 3100 may include internal function blocks for performing functions of the host device.

The host device 3100 may include a connection terminal 3110 such as a socket, a slot, or a connector. The data storage device 3200 may be mounted on the connection terminal 3110.

The data storage device 3200 may be configured in the form of a board such as a printed circuit board. The data storage device 3200 may refer to a memory module or a memory card. The data storage device 3200 may include a controller 3210, a buffer memory device 3220, nonvolatile memories 3231 and 3232, a power management integrated circuit (PMIC) 3240, and a connection terminal 3250.

The controller 3210 may control overall operation of the data storage device 3200. The controller 3210 may be configured in the same manner as the controller 2210 shown in FIG. 12.

The buffer memory device 3220 may temporarily store data to be stored in the nonvolatile memories 3231 and 3232. Further, the buffer memory device 3220 may temporarily store data read out from the nonvolatile memories 3231 and 3232. The data temporarily stored in the buffer memory device 3220 may be transmitted to the host device 3100 or the nonvolatile memories 3231 and 3232 according to control of the controller 3210.

The nonvolatile memories 3231 and 3232 may be used as storage media of the data storage device 3200.

The PMIC 3240 may provide power inputted through the connection terminal 3250, to the inside of the data storage device 3200. The PMIC 3240 may manage the power of the data storage device 3200 according to control of the controller 3210.

The connection terminal 3250 may be coupled to the connection terminal 3110 of the host device 3100. Through the connection terminal 3250, signals such as commands, addresses, data and the like and power may be transferred between the host device 3100 and the data storage device 3200. The connection terminal 3250 may be configured as any of various types depending on an interface scheme between the host device 3100 and the data storage device 3200. The connection terminal 3250 may be disposed on or in any side of the data storage device 3200.

FIG. 14 is a block diagram illustrating a data processing system including a data storage device according to an embodiment. Referring to FIG. 14, a data processing system 4000 may include a host device 4100 and a data storage device 4200.

The host device 4100 may be configured in the form of a board such as a printed circuit board. Although not shown in FIG. 14, the host device 4100 may include internal function blocks for performing functions of the host device.

The data storage device 4200 may be configured in the form of a surface-mounting type package. The data storage device 4200 may be mounted on the host device 4100 through solder balls 4250. The data storage device 4200 may include a controller 4210, a buffer memory device 4220, and a nonvolatile memory 4230.

The controller 4210 may control overall operation of the data storage device 4200. The controller 4210 may be configured in the same manner as the controller 2210 shown in FIG. 12.

The buffer memory device 4220 may temporarily store data to be stored in the nonvolatile memory 4230. Further, the buffer memory device 4220 may temporarily store data read out from the nonvolatile memory 4230. The data temporarily stored in the buffer memory device 4220 may be transmitted to the host device 4100 or the nonvolatile memory 4230 according to control of the controller 4210.

The nonvolatile memory 4230 may be used as a storage medium of the data storage device 4200.

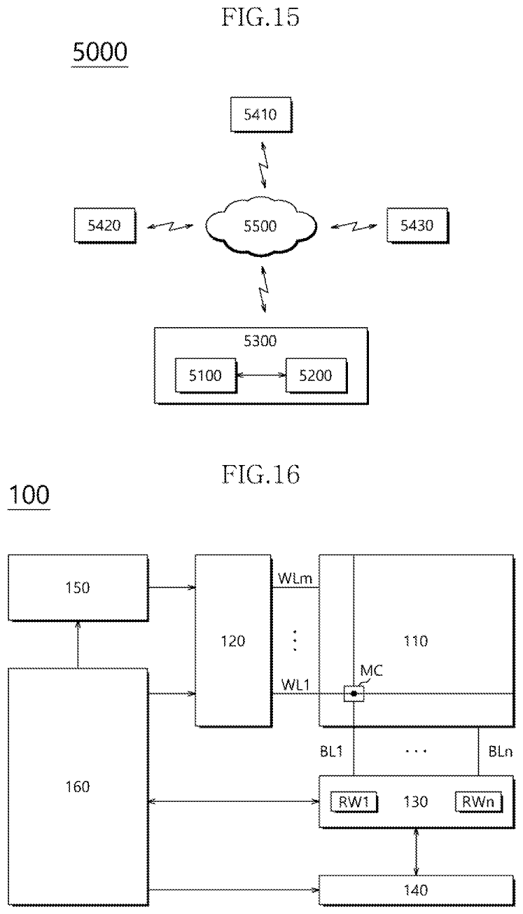

FIG. 15 is a diagram illustrating a network system 5000 including a data storage device according to an embodiment. Referring to FIG. 15, the network system 5000 may include a server system 5300 and a plurality of client systems 5410 to 5430 which are coupled to each other through a network 5500.

The server system 5300 may service data in response to requests from the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host device 5100 and a data storage device 5200. The data storage device 5200 may be configured as the data storage device 10 illustrated in FIG. 1, the data storage device 2200 illustrated in FIG. 11, the data storage device 3200 illustrated in FIG. 13, or the data storage device 4200 illustrated in FIG. 14.

FIG. 16 is a block diagram illustrating a nonvolatile memory included in a data storage device according to an embodiment. Referring to FIG. 16, the nonvolatile memory 100 may include the memory cell array 110, a row decoder 120, a data read/write block 130, a column decoder 140, a voltage generator 150, and control logic 160.

The memory cell array 110 may include the memory cells MC which are arranged in regions where the word lines WL1 to WLm and the bit lines BL1 to BLn cross each other.

The row decoder 120 may be coupled with the memory cell array 110 through the word lines WL1 to WLm. The row decoder 120 may operate according to control of the control logic 160. The row decoder 120 may decode addresses provided from an external device (not shown). The row decoder 120 may select and drive the word lines WL1 to WLm, based on the decoding results. For example, the row decoder 120 may provide word line voltages provided from the voltage generator 150, to the word lines WL1 to WLm.

The data read/write block 130 may be coupled with the memory cell array 110 through the bit lines BL1 to BLn. The data read/write block 130 may include read/write circuits RW1 to RWn corresponding to the bit lines BL1 to BLn. The data read/write block 130 may operate according to control of the control logic 160. The data read/write block 130 may operate as a write driver or a sense amplifier according to an operation mode. For example, the data read/write block 130 may operate as a write driver which stores data provided from the external device, in the memory cell array 110 in a write operation. In another example, the data read/write block 130 may operate as a sense amplifier which reads out data from the memory cell array 110 in a read operation.

The column decoder 140 may operate according to control of the control logic 160. The column decoder 140 may decode addresses provided from the external device. The column decoder 140 may couple data input/output lines (or data input/output buffers) with the read/write circuits RW1 to RWn of the data read/write block 130 which respectively correspond to the bit lines BL1 to BLn, based on decoding results.

The voltage generator 150 may generate voltages to be used in internal operations of the nonvolatile memory 100. The voltages generated by the voltage generator 150 may be applied to the memory cells MC of the memory cell array 110. For example, a program voltage generated in a program operation may be applied to a word line of memory cells on which the program operation is to be performed. In another example, an erase voltage generated in an erase operation may be applied to a well region of memory cells on which the erase operation is to be performed. In still another example, a read voltage generated in a read operation may be applied to a word line of memory cells on which the read operation is to be performed.

The control logic 160 may control overall operation of the nonvolatile memory 100, based on control signals provided from the external device. For example, the control logic 160 may control operations of the nonvolatile memory 100 such as read, write, and erase operations of the nonvolatile memory 100.

The above described embodiments of the present invention are intended to illustrate, not limit the present invention. Various alternatives and equivalents are possible, as those skilled in the art will appreciate in light of the present disclosure. The invention is not limited by or to any of the embodiments described herein. Nor is the invention limited to any specific type of semiconductor device. Rather, the present invention encompasses all variations and modifications that fall within the scope of the appended claims.

What is claimed is:

1. A data storage device comprising:
a first data storage device configured to:
transmit a request for metadata to a second data storage device, receive the metadata from the second data storage device, and store the metadata therein when the data storage device satisfies a sleep condition and switches to a sleep mode; and
transfer the metadata of the second data storage device, which is stored in the first data storage device, to the data storage device when the second data storage device switches from the sleep mode to a wake-up mode; and
the second data storage device configured to transmit metadata stored therein, when the request for the metadata is received from the first data storage device, to the first data storage device in response to the request for the metadata.

2. The data storage device of claim 1, wherein the first data storage device includes:
a processor configured to:
request and receive the metadata from the second data storage device and store the metadata and a management table matched with the metadata in a memory when the sleep condition is satisfied; and
transmit the stored metadata to the second data storage device based on information of the management table when a wake-up condition of the data storage device is satisfied and the data storage device is switched from the sleep mode to the wake-up mode; and
the memory configured to store the metadata and the management table and provide the stored metadata and the stored management table according to a request of the processor.

3. The data storage device of claim 2, wherein the management table includes identification information of the second data storage device, including a type of the memory in which the metadata is stored and a position where the metadata is stored within the memory, and a size of the stored metadata.

4. The data storage device of claim 2,
wherein the second data storage device includes multiple second data storage devices, distinct from one another,
wherein the memory includes a volatile memory and a nonvolatile memory, and
wherein the processor stores all the metadata of the multiple second data storage devices in the volatile memory or the nonvolatile memory, or the processor divides the metadata of the multiple second data storage devices and stores metadata of one or more of the multiple second data storage devices in the volatile memory and stores metadata of one or more other second data storage devices in the nonvolatile memory.

5. The data storage device of claim 4, wherein the nonvolatile memory is configured with single-level cells.

6. The data storage device of claim 1, wherein the second data storage device includes one or more data storage devices, and
the first data storage device and the second data storage device have an equal connection relationship that the first and second data storage devices are directly coupled to a host device, respectively, or have a subordinate relationship that the first data storage device or any one of second data storage devices is directly coupled to the host device and other than the one data storage device directly coupled to the host device, remaining data storage devices are coupled to the one data storage device directly coupled to the host device.

7. The data storage device of claim 1, wherein the metadata is for operating firmware of the second data storage device.

8. A storage system comprising:
a host device configured to set any one of a plurality of data storage devices as a first data storage device and set remaining data storage devices as a second data storage device, based on sleep environment conditions; and
the plurality of data storage devices including the first data storage device and the second data storage device, wherein the first data storage device transmits a request for metadata to the second data storage device, receives the metadata from the second data storage device, and stores the metadata when the plurality of data storage devices satisfy a sleep condition and switch to a sleep mode and transfers pre-stored metadata of the second data storage device to the corresponding second data storage device when the plurality of data storage devices switch from the sleep mode to a wake-up mode.

9. The storage system of claim 8,
wherein the host device requests and receives the sleep environment conditions from the plurality of data storage devices,
wherein the sleep environment conditions received from each of the plurality of data storage devices include an estimated current consumption amount to maintain the metadata in a memory in the sleep mode, an available memory space, and a size of the metadata to be maintained in a sleep state.

10. The storage system of claim 9, wherein the host device sets the data storage device having the largest available memory space among the plurality of data storage devices as the first data storage device.

11. The storage system of claim 10, wherein, the host device sets the data storage device having the smallest estimated current consumption amount among the plurality of data storage devices, as the first data storage device.

12. The storage system of claim 8, wherein the first data storage device includes:
a processor configured to:
request and receive the metadata from the second data storage devices and store the metadata and a management table matched with the metadata in a memory when the sleep condition is satisfied; and
transmit the stored metadata to the second data storage devices based on information of the management table when a wake-up condition of the plurality of data storage devices is satisfied and the sleep mode is switched to the wake-up mode; and
the memory configured to store the metadata and the management table and provide the stored metadata and the stored management table according to a request of the processor.

13. The storage system of claim 12, wherein the management table includes identification information for each of the second data storage devices, including a type of the memory in which the metadata is stored, a position where the metadata is stored within the memory, and a size of the stored metadata.

14. The storage system of claim 12,
wherein the memory includes a volatile memory and a nonvolatile memory, and
wherein the processor stores all the metadata of the second data storage devices in the volatile memory or the nonvolatile memory or the processor divides the metadata of the second data storage devices and stores metadata of a first subset of the second data storage devices in the volatile memory and stores metadata of a second subset of the second data storage devices in the nonvolatile memory.

15. The storage system of claim 14, wherein the nonvolatile memory is configured with single-level cells.

16. The storage system of claim 8, wherein the second data storage device includes one or more data storage devices, and
the first data storage device and the second data storage device have an equal connection relationship that the first and second data storage devices are directly coupled to the host device, respectively, or have a subordinate relationship that the first data storage device or any one of the second data storage devices is directly coupled to the host device and other than the one data storage device directly coupled to the host device, remaining data storage devices are coupled to the one data storage device directly coupled to the host device.

17. An operating method of first and second data storage devices, the method comprising:
transmitting, by the first data storage device, a request for metadata to the second data storage device when a sleep condition for the first and second data storage device is satisfied;
transmitting, by the second data storage device, the metadata to the first data storage device in response to the request;
storing, by the first data storage device, the metadata of the second data storage device and a management table matched with the metadata in a memory of the first data storage device; and
transmitting, by the first data storage device, the stored metadata to the second data storage device based on information of the stored management table when a wake-up condition of the first and second data storage device is satisfied and switches from a sleep mode to a wake-up mode.

18. The method of claim 17, where the management table includes identification information of the second data storage device, a type of the memory in which the metadata is stored, a position where the metadata is stored within the memory, and a size of the stored metadata.

19. The method of claim 17,
wherein the memory is a volatile memory or a nonvolatile memory, and
wherein the processor stores all the metadata in the volatile memory or the nonvolatile memory or the processor divides the metadata and stores divided metadata in the volatile memory and the nonvolatile memory, respectively.
